(19) United States
(12) Patent Application Publication
(10) Pub. No.: US 2012/0209488 A1
(43) Pub. Date: Aug. 16, 2012

(54) ERRONEOUS PEDAL DEPRESSION HANDLING APPARATUS FOR MOTOR VEHICLE AND COMPUTER PROGRAM FOR IMPLEMENTING FUNCTIONS OF THE VEHICLE

(75) Inventor: Takumi Nagaya, Kariya-shi (JP)

(73) Assignee: DENSO CORPORATION, Kariya-city (JP)

(21) Appl. No.: 13/368,783

(22) Filed: Feb. 8, 2012

(30) Foreign Application Priority Data
Feb. 11, 2011 (JP) 2011-027993

(51) Int. Cl. G06F 19/00

(52) U.S. Cl. 701/70

(57) ABSTRACT

In an apparatus for handling erroneous depression of the accelerator pedal of a vehicle, after control has been applied for partially or completely preventing the vehicle from being accelerated in response to actuation of the accelerator pedal, normal acceleration control is restored thereafter by a number of steps of successive decrease of the degree of acceleration restriction. Each step may be executed in response to some specific action performed by the vehicle driver, or each time a specific time interval elapses after commencement of the acceleration restriction.

### CROSS-REFERENCE TO RELATED APPLICATIONS

This application is based on and incorporates herein by reference Japanese Patent Application No. 2011-027993 filed on 11 Feb. 2011.

### BACKGROUND OF THE INVENTION

1. Field of Application

The present invention relates to an apparatus for handling erroneous actuation of the accelerator pedal of a motor vehicle, by restricting acceleration of the vehicle when the pedal is strongly depressed accidentally, and to a program executed by a computer for performing the functions of such an is apparatus.

2. Background of the Invention

Types of apparatus are known for use in detecting erroneous depression of the accelerator pedal of a vehicle, and for applying control to counteract the effects of such erroneous depression, e.g., by restricting motion of the vehicle. Such types of apparatus also employ technology for subsequently canceling such control, for example when the accelerator pedal becomes completely released. Here “erroneous pedal depression” signifies that the vehicle driver accidentally depresses the accelerator pedal abnormally rapidly. Specifically, if the driver gradually depresses the accelerator pedal to a specific position, the vehicle will move with a moderate value of acceleration until a specific speed is reached. However if the driver depresses the accelerator pedal very rapidly, sudden high acceleration will occur.

An example of such a type of apparatus is disclosed in Japanese patent publication No. 9-301012. With that apparatus, after erroneous pedal depression has been detected and handled (by applying control for restricting acceleration of the vehicle), the vehicle driver can immediately cancel all restriction control simply by releasing the accelerator pedal. This has the advantage of rapid cancellation response. However when the driver erroneously depresses the accelerator pedal, he or she may become agitated, or the incident may result from the driver being in an agitated condition (e.g., as may occur immediately after the vehicle has collided with an obstacle). Furthermore when the restriction control is released, the vehicle may continue to move slowly (for example when the vehicle has an automatic transmission, “creeping” may occur). If the acceleration restriction control is completely released before the driver has reached a calm state of mind, the driver may then again erroneously depress the accelerator pedal.

It might be considered that the acceleration restriction control should be cancelled only if the driver performs some action (or combination of actions) indicating a calm state of mind, e.g., if the driver sets the transmission to the P (parking) range while also engaging the parking brake. However this is not always satisfactory, since some type of troublesome operation must be performed by the driver.

Alternatively, the apparatus could be configured such that the acceleration restriction control will be released only after a predetermined time interval has elapsed after the control commences, i.e., sufficient time for the driver to recover a calm state of mind. However if acceleration is always completely prevented during that interval, the driver may become anxious or irritated.

The effect of depressing the accelerator pedal is generally referred to as “opening the accelerator”, and the rate of accelerator opening can be detected as the rate (detected change in position per unit of time) at which the accelerator pedal is being depressed.

### SUMMARY

Hence it is desired to overcome the above problems by providing an erroneous pedal depression handling apparatus which ensures enhanced safety, while also having response characteristics whereby a user does not tend to be made anxious by operation of the apparatus. The functions described herein for the apparatus are preferably performed by a computer in executing a stored program, however at least some of these function could be performed by hardware circuits.

From a first aspect, the disclosure provides, an erroneous pedal depression handling apparatus for installation in a motor vehicle, the vehicle being equipped with actuators which can be controlled to vary the degree to which the vehicle accelerates in response to any specific rate of depressing the accelerator pedal of the vehicle. Here the term “actuators” is used in a general sense, to signify a device or combination of devices such as an engine ECU and throttle valve, hydraulic brake valves, etc., which can be used in controlling acceleration of the vehicle. The apparatus basically comprises three system modules, i.e., an erroneous pedal actuation control module, a control cancellation module, and a vehicle control module. The erroneous pedal actuation control module detects erroneous (excessively rapid) depressing of the accelerator pedal of the vehicle, and in response selects one of a plurality of stepwise-varying control levels, and transmits corresponding control contents to the vehicle control module. The control levels successively increase in accordance with successively increasing degrees of acceleration restriction. The control contents are supplied to the vehicle control module, which controls actuators of the vehicle (e.g., engine ECU, etc.) such as to partially or completely restrict acceleration.

One or more sensors of the vehicle are designated as cancellation sensors, used for detecting specific events referred to in the following cancellation events, which are predetermined as opportunities for partially or completely canceling the acceleration restriction control. Each time a cancellation event is detected (e.g., when the driver releases the accelerator pedal or depresses the brake pedal), the control cancellation module determines a lower control level, and supplies corresponding control contents to be applied by the vehicle control module. The degree of acceleration restriction control can thereby be reduced in successive stages, until normal acceleration control is restored to the driver.

Such an apparatus provides advantages both from the aspects of safety and of rapid response to driver, for the following reasons. After erroneous accelerator pedal depression has been detected, if for example control has been applied to completely prevent acceleration of the vehicle, this control cannot be immediately cancelled by a simple action of the vehicle driver, such as releasing the accelerator pedal. Specifically, the control is cancelled thereafter in the sequence: [completely inhibit acceleration→partially enable acceleration→completely enable acceleration]. Thus, a plurality of cancellation events (cancellation opportunities) must occur, before the restriction control is completely cancelled. By that time, it is probable that the driver will have recovered a calm state of mind. Hence, safety is enhanced.

The vehicle can thereby be safely restored to a condition of normal acceleration control with a minimum of delay. However on the other hand, if the driver again depresses the accelerator pedal abnormally rapidly, before control by the vehicle control module has been completely released, sudden acceleration is reliably prevented. Safety is thereby further enhanced.

The apparatus is preferably configured to use two categories of cancellation sensor. When a cancellation event is detected by a cancellation sensor of the first category, the control cancellation module partially reduces the degree of acceleration restriction (by lowering the control level by 1 step). When a cancellation event is detected by the second type of cancellation sensor, acceleration restriction is immediately terminated completely. The second type of cancellation sensor can for example (in the case of a vehicle having an automatic transmission) consist of a combination of a parking brake sensor and transmission range selector sensor. In that case, the driver can immediately restore normal control of acceleration by setting the transmission to the P (parking) range while also engaging the parking brake. Such a combination of actions performed by the driver indicates a calm state of mind, so that normal operation of the vehicle can be safely restored immediately.

Erroneous accelerator pedal depression is preferably detected as a condition in which the rate of throttle opening (e.g., measured as a detected rate of depressing the accelerator pedal) exceeds a predetermined judgement threshold value. From another aspect, the erroneous pedal actuation control module is preferably configured to select a control level which is increased by successive steps in accordance with increase of an amount (referred to herein as the deviation extent) by which the judgement threshold value is exceeded. The reason for this is as follows. When the accelerator pedal is rapidly depressed accidentally, the necessary degree of acceleration restriction can be considered to depend upon the speed at which the accelerator pedal is moved. By selecting the control level as described above, with corresponding control contents being implemented by the vehicle control module, acceleration is increasingly restricted in a stepwise manner, in accordance with increase of the speed with which the accelerator pedal is depressed. Appropriate restriction control is thus applied.

When the vehicle is equipped with a plurality of status estimation sensors, for detecting respective statuses of the vehicle or of the environment of the vehicle (e.g., detecting the direction of slope and gradient of slope of a surface on which the vehicle is situated), the erroneous pedal actuation control module is preferably configured to adjust the judgement threshold value in accordance with detection signals received from the status estimation sensors. The advantage of this is as follows. The appropriate decision as to whether erroneous accelerator pedal depression occurs will depend upon the actual circumstances of the vehicle at that time. For example, if the vehicle is currently running on a steep downhill slope, or a door of the vehicle is open, it is unlikely that the driver will deliberately depress the accelerator pedal strongly. Hence, the judgement threshold value should be lower than when the vehicle is running on a level surface. Similarly, the threshold value should be increased when the vehicle is running on a steep uphill slope.

### BRIEF DESCRIPTION OF THE DRAWINGS

FIG. 1 is a block diagram of a vehicle system incorporating a preferred embodiment of an erroneous pedal depression handling apparatus;

FIG. 2 is a flow diagram of a processing sequence executed by an erroneous pedal actuation control section of the embodiment;

FIG. 3 is a table showing relationships between respective internal and external statuses of the vehicle, corresponding judgement conditions, and corresponding adjusted values of a judgement threshold value;

FIG. 4 is a table showing relationships between extents of deviation from the judgement threshold value, corresponding control levels, and corresponding control contents for effecting acceleration restriction;

FIG. 5 is a flow diagram of a processing sequence executed by a control cancellation section of the embodiment;

FIG. 6 is a table showing relationships between cancellation events, corresponding control levels at which partial or complete cancellation of acceleration restriction is possible, and corresponding cancellation amounts; and

FIG. 7 is a diagram illustrating examples of acceleration restriction cancellation, for the case of a succession of partial cancellations in response to successive cancellation events and for the case of complete cancellation in response to a single cancellation event.

### DESCRIPTION OF PREFERRED EMBODIMENTS

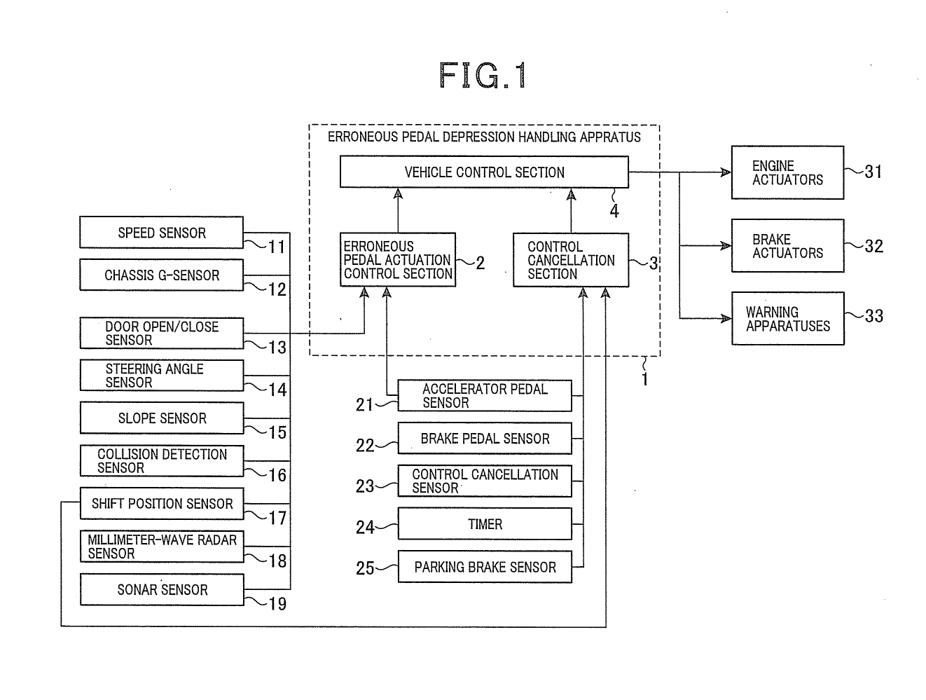

An embodiment of an erroneous pedal depression handling apparatus, installed in a motor vehicle, is described in the following. FIG. 1 is a block diagram showing the overall configuration of a vehicle system incorporating the embodiment, designated by numeral 1. As shown, the vehicle system includes sensors 11 to 25 and engine actuators 31, brake actuators 32 and warning apparatuses 33 in addition to the erroneous pedal depression handling apparatus 1.

The vehicle of this embodiment is driven by an internal combustion engine and automatic transmission (not shown in the drawings), with the engine power output being controlled by the engine actuators 31. The engine actuators 31 include a fuel injection apparatus, fuel ignition apparatus, throttle valve opening/closing apparatus, etc. The brake actuators 32 control the braking force applied by the brakes of the vehicle, and include valves of a hydraulic braking system, electric motors for driving hydraulic pumps, etc. The warning apparatuses 33 supply warnings to the vehicle driver, and include an audio output apparatus for generating audible warning signals within the vehicle and a display apparatus for displaying visual warning indications within the vehicle.

The engine actuators 31, brake actuators 32 and warning apparatuses 33 are controlled to restrict acceleration of the vehicle when erroneous depression of the accelerator pedal is detected. For example by controlling the engine actuators 31, the throttle valve of the engine can be held substantially closed, thereby restricting acceleration even if the accelerator pedal is strongly depressed. Similarly when the brake actuators 32 is controlled to perform braking intervention (i.e., superimposed on any braking action that may be performed by the vehicle driver), there is a reduced possibility that the vehicle will accelerate, even if the driver strongly depresses the accelerator pedal. Furthermore when the warning apparatuses 33 are controlled to generate warnings to the driver, indicating that the accelerator pedal should not be depressed at that time, this reduces the possibility that the vehicle will be accelerated, since it reduces the probability that the driver will depress the accelerator pedal.

The speed sensor 11 and the chassis G-sensor 12 constitute respective scene estimation sensors. The term “scene” is used here to refer to separate speed conditions (speed ranges) of the vehicle, i.e., with this embodiment, a condition in which the vehicle is stationary or moving at very low speed, and a condition in which the vehicle is running at a normal (higher) speed. The door open/close sensor 13, steering angle sensor 14, slope sensor 15, collision detection sensor 16, shift position sensor 17, millimeter-wave radar apparatus 18 and sonar detection apparatus 19 serve as respective status detection sensors, for detecting respective internal conditions of the vehicle or conditions of the environment of the vehicle. The shift position sensor 17 also serves as a cancellation sensor, as do to the accelerator pedal sensor 21, brake pedal sensor 22, cancellation switch 23, timer 24 and parking brake sensor 25. The cancellation sensors are used to detect cancellation events, i.e., events which constitute opportunities for partially or completely canceling acceleration restriction control which is currently being applied to the engine actuators 31, brake actuators 32 and warning apparatuses 33. In particular, each time a specific interval (with this embodiment, 3 seconds) has elapsed (with the timing commencing at the point when acceleration restriction control is commenced) a detection signal is outputted by the timer 4, as a cancellation event.

With this embodiment the functions of erroneous pedal actuation control section 2, control cancellation section 3 and vehicle control section 4 of the erroneous pedal depression handling apparatus 1 are implemented by a program executed by a computer, the computer being formed of a CPU, ROM, RAM, I/O circuits, etc., as is well known, with the program being held stored in the ROM and with the CPU using the RAM as a working memory.

When erroneous depression of the accelerator pedal is detected, the erroneous pedal actuation control section 2 initially selects one of a plurality of stepwise-varying control levels and supplies corresponding control contents (first control contents) to the vehicle control section 4. With this embodiment there are three possible non-zero control levels, increasing by successive steps in accordance with increasing strength of acceleration restriction. The erroneous pedal actuation control section 2 selects the control level in accordance with the speed at which the accelerator pedal is depressed, based on the detection signal from the accelerator pedal sensor 21. The vehicle control section 4 controls the engine actuators 31, brake actuators 32 and warning apparatuses 33 in accordance with the supplied control contents, to restrict acceleration of the vehicle.

When an event predetermined as a cancellation event subsequently occurs, the control cancellation section 3 lowers the control level by one or more steps (determined in accordance with the type of cancellation event as described hereinafter) and transmits control contents (second control contents) corresponding to the resultant lowered control level to the vehicle control section 4. The vehicle control section 4 applies these second control contents, thereby partially or completely releasing control of the engine actuators 31, brake actuators 32 and warning apparatuses 33.

The engine actuators 31 are normally controlled by an engine ECU (electronic control unit, not shown in the drawings) for achieving a requested degree of acceleration. The requested degree of acceleration is expressed by the rate at which the accelerator pedal is depressed (i.e., rate of change of accelerator pedal position per unit of time). When erroneous depression of the accelerator pedal has been detected, the vehicle control section 4 controls the engine actuators 31 to restrict the actual acceleration to be less than the requested degree of acceleration or to completely inhibit acceleration, as described hereinafter.

The brake actuators 32 is normally controlled by a brake ECU (not shown in the drawings) for achieving a required degree of deceleration of the vehicle in accordance with actuation of the brake pedal. However as described above the vehicle control section 4 can control the brake actuators 32 to effect braking intervention.

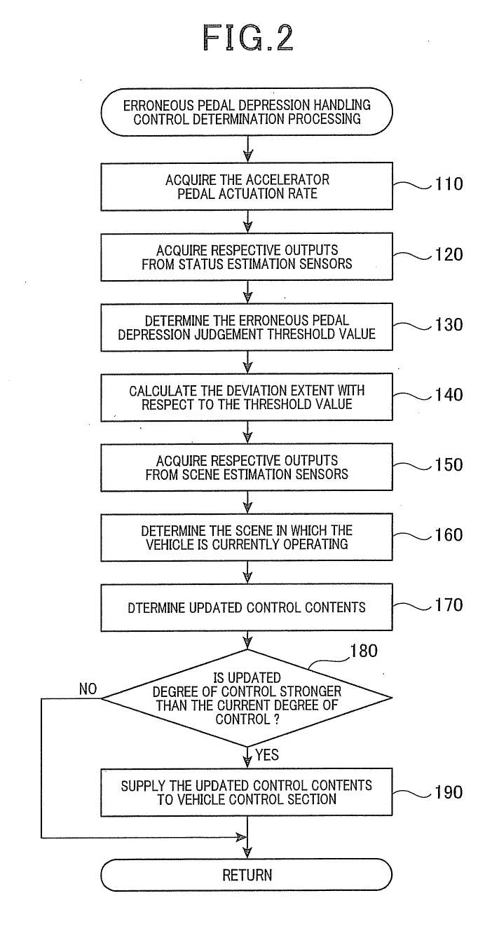

Details of operation of the vehicle system of FIG. 1 are described in the following, referring first to FIG. 2, which is a flow diagram of a processing sequence repetitively executed by the erroneous pedal actuation control section 2.

Firstly (step 110), the erroneous pedal actuation control section 2 acquires the accelerator opening rate, expressed as a rate of accelerator pedal depression per unit of time, based on a detection signal from the accelerator pedal sensor 21.

Next (step 120) detection signals are respectively acquired from the status estimation sensors 11 to 17. In the following step (step 130) a judgement threshold value is determined based on the results obtained in step S120, for use in judging whether erroneous depression of the accelerator pedal occurs and if so, the extent to which this occurs.

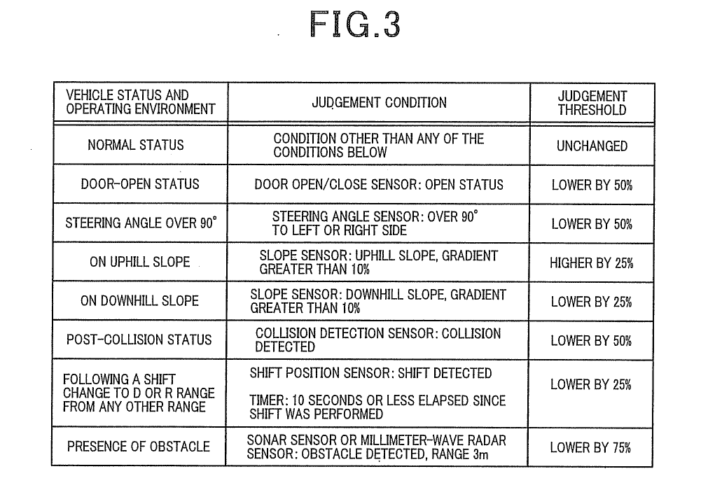

FIG. 3 is a table showing the relationship between each of a number of is different status items concerning the vehicle, respectively corresponding judgement conditions, and corresponding amounts of adjustment of the judgement threshold value. As shown, each status item may consist of a status of the vehicle itself or of the environment in which the vehicle is operating (e.g., presence of an obstacle). The status items are as follows.

The “normal” status is a condition in which none of the listed status items is detected, and the judgement threshold value used in the case of the normal status is unchanged from a predetermined normal value.

Door open: this is judged based on a detection signal received from the door open/close sensor 13, indicating that a door of the vehicle is open. If the “door open” status is detected, the judgement threshold value is lowered by 50% (i.e., is decreased to 50% of the normal value).

Steering angle 90° or more: this status is judged to exist when a detection signal from the steering angle sensor 14 indicates that the steering angle of the vehicle is 90° or more (i.e., deviates by 90° or more to the left side or to the right side, with respect to the straight-ahead steering angle). If this status is detected, the judgement threshold value is lowered by 50%.

Uphill slope: the (front-to-rear) angle of deviation of the vehicle from a horizontal condition is detected by the slope sensor 15. When a detection signal received from the slope sensor 15 indicates that the vehicle is on an uphill slope with a gradient of 10% or more, it is judged that the “uphill slope” status exists, and the judgement threshold value is increased by 25%.

Downhill slope: when the detection signal received from the slope sensor 15 indicates that the vehicle is on a downhill slope with a gradient of 10% or more, it is judged that the “downhill slope” status exists, and the judgement threshold value is decreased by 25%.

Collision-subsequent: when a collision detection signal is received from the collision detection sensor 16, indicating that the vehicle has collided with an obstacle, the “collision-subsequent” status is judged to exist, and the judgement threshold value is decreased by 50%.

Shift change-subsequent: when the shift position (of the automatic transmission of the vehicle) is changed to the D (drive) range or to the R (reverse) range, this change is detected by the shift position sensor 17 and a corresponding detection signal is produced. Based on that detection signal, the “shift change-subsequent” status is judged to exist during a predetermined interval (for example, 10 seconds) after such a change is detected. During that interval, the judgement threshold value is held decreased by 25%.

Obstacle presence: the millimeter-wave radar apparatus 18 and the sonar detection apparatus 19 are used to detect any object in the environment of the vehicle which presents a danger of collision. Based on detection signals received from the millimeter-wave radar apparatus 18 and sonar detection apparatus 19, the distance to such an obstacle and the rate of change of that distance (relative speed) are derived. If the distance and relative speed are such that the time until collision with the obstacle is less than a predetermined reference interval (e.g., 1.5 seconds), the “obstacle presence” status is judged to exist, and the judgement threshold value is decreased by 75%.

Next in step 140 of FIG. 2, the judgement threshold value determined in step 130 is compared with the accelerator opening rate which was acquired in step S110, to obtain the deviation extent. Here, deviation extent signifies a stepwise-varying category (“small”, “medium”, or “large”) that is assigned in accordance with the extent to which the accelerator opening rate exceeds the judgement threshold value.

Next in step 150, the vehicle speed is calculated based on detection signals acquired from the speed sensor 11 and chassis G-sensor 12, i.e., a vehicle speed pulse signal received from the speed sensor 11 and a vehicle acceleration value (forward or reverse direction) received from the chassis G-sensor 12. If the calculated speed is less than a reference value (with this embodiment, 10 km/h), the vehicle is judged to be operating in a speed range designated as the starting/low-speed running scene, while if the calculated speed is equal to or greater than the reference speed value, the vehicle is judged to be operating in a speed range designated as the normal running scene. If erroneous depression of the accelerator pedal occurs during the starting/low-speed running scene, it is probable that the vehicle driver has accidentally depressed the accelerator pedal rapidly while attempting to move the vehicle. If erroneous depression of the accelerator pedal is detected in the normal running scene, it is probable that the driver has mistakenly depressed the accelerator pedal instead of the brake pedal, when attempting to stop the vehicle.

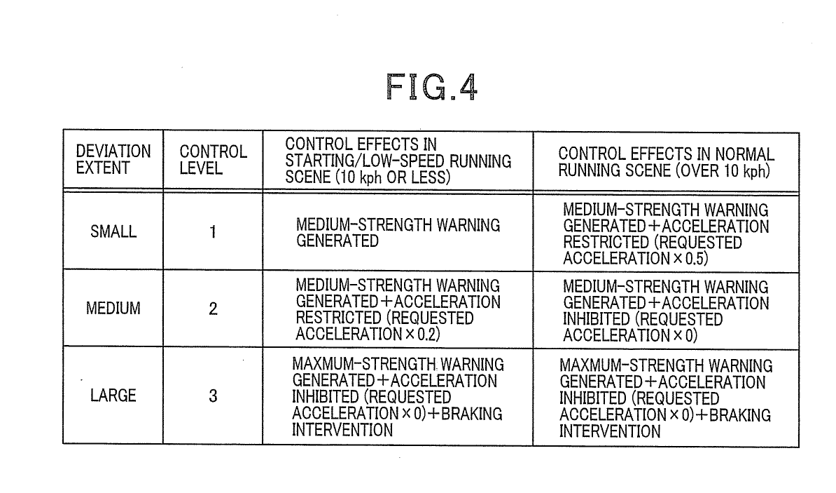

Next in step 170, the control contents to be applied to the engine actuators 31, brake actuators 32 and warning apparatuses 33 are determined based on the deviation extent and the scene which was determined in step 160. The table of FIG. 4 illustrates control contents corresponding to the “small”, “medium” and “large” deviation extents.

As shown in FIG. 4, one of the stepwise-varying control levels 1, 2 and 3 is selected in accordance with whether the “small”, “medium” or “large” deviation extent has been determined in step 170, and control contents are determined in accordance with the selected control level and the scene (speed range) in which the vehicle is currently operating, as follows.

Control Contents Assigned in Starting/Low-Speed Running Scene

Control level 1 (“small” deviation extent):

The control contents corresponding to control level 1 are allocated such that the vehicle control section 4 controls the warning apparatuses 33 to to generate a medium-strength warning. Specifically, this could consist of audible and visual warning indications that are generated momentarily. No control is applied by the vehicle control section 4 to the engine actuators 31 or the brake actuators 32.

Control level 2 (“medium” deviation extent):

The control contents corresponding to control level 2 are allocated such that the vehicle control section 4 controls the warning apparatuses 33 to generate a medium-strength warning, and controls the engine actuators 31 to apply a medium degree of acceleration restriction. No control is applied by the vehicle control section 4 to the brake actuators 32. The medium degree of acceleration restriction can for example be such that (for the same rate of depressing the accelerator pedal) the acceleration becomes 0.2 times the value during normal operation.

Control level 3 (“large” deviation extent):

The control contents corresponding to control level 3 are allocated such that the vehicle control section 4 controls the warning apparatuses 33 to generate a maximum-strength warning, controls the engine actuators 31 to apply a maximum degree of acceleration restriction, and controls the brake actuators 32 to effect braking intervention. Here, “maximum degree of acceleration restriction” signifies that the acceleration is held at zero irrespective of how the accelerator pedal is actuated.

Control Contents Assigned in Normal Running Scene

During operation in the normal running scene, the control contents corresponding to the control levels 1, 2 and 3 are allocated and function in a similar manner to those for the starting/low-speed running scene. However as shown in FIG. 4, when the vehicle is operating in the normal running scene, the control contents corresponding to the control levels 1 and 2 cause the vehicle control section 4 to apply greater restriction of acceleration than for operation in the starting/low-speed running scene.

In step 180 following step 190 of FIG. 2, a decision is made as to whether the control contents determined in step 170 are stronger (will have a greater acceleration-restricting effect) than the control contents currently being applied by the vehicle control section 4. If the control contents will become stronger, then step 190 is executed, while otherwise, operation returns to step 110.

In step 190, the control contents determined in step 170 are outputted to the vehicle control section 4, and applied to control the engine actuators 31, brake actuators 32 and warning apparatuses 33 accordingly.

The operation of the erroneous pedal actuation control section 2 and the vehicle control section 4 has the following effects. It will be assumed for example that an (apparent) erroneous depression of the accelerator pedal is detected while the vehicle is running at low speed (below 10 kph) on an uphill slope with a gradient of more than 10%. In response to the detection signal received from the slope sensor 15 in step 120 of FIG. 2, the erroneous pedal actuation control section 2 increases the judgement threshold value to become 25% higher than the normal value (step 130 of FIG. 3) then compares the accelerator opening rate with the resultant increased judgement threshold value (step 140) to obtain the deviation extent. The current scene is then determined in step 160 (i.e., the starting/low-speed running scene). The one of the control levels 1 to 3 which corresponds to the deviation extent is then selected, and first control contents corresponding to the selected control level (for the case of operation in the starting/low-speed running scene) are then determined (step 170) using the relationships shown in FIG. 4.

It will then be judged in step 180 that the currently applied degree of acceleration restriction (i.e., zero) is less than the restriction which will result from the newly determined first control contents (hence, YES decision in step 180). Thus these control contents are then supplied by the erroneous pedal actuation control section 2 to the vehicle control section 4/Step 190), to be applied in controlling the engine actuators 31, brake actuators 32 and warning apparatuses 33.

When an (apparent) erroneous depression of the accelerator pedal is detected while the vehicle is on a steep uphill slope having a gradient of 10% or more, it is possible that the vehicle driver has deliberately depressed the accelerator pedal strongly, to obtain increased power from the engine. Hence in such a case, the judgement threshold value is increased by 25%, so that (for the same rate of accelerator opening) the calculated deviation extent will be made less than when the vehicle is on a level surface or a downhill surface, and the selected control level will thus tend to be lower, with a correspondingly lower degree of acceleration restriction.

Conversely, if the vehicle is running on a downhill slope with a gradient of 10% or more, or a door of the vehicle is open, or the steering angle is greater than 90°, or the vehicle is in a condition immediately following a collision, or in a condition immediately after the vehicle transmission has been shifted to the D or to the R range, or when the presence of an obstacle is detected, there will only be a low possibility that the vehicle driver has deliberately depressed the accelerator pedal rapidly. Hence in such a case the judgement threshold value is reduced below the normal value. As a result, (for the same rate of accelerator opening) the deviation extent will be increased. The control level selected by the erroneous pedal actuation control section 2 will tend to be increased accordingly, and the degree of acceleration restriction increased thereby.

Thus with this embodiment, the judgement threshold value (for determining whether or not erroneous depression of the accelerator pedal occurs) is adjusted in accordance with internal and internal conditions of the vehicle at the time, e.g., is increased if the vehicle is running on a steep uphill slope, or is reduced if a door of the vehicle is open, as shown by FIG. 3.

Furthermore, if erroneous depression of the accelerator pedal is detected, the appropriate extent to which acceleration should be restricted (as expressed by the first control contents) depends upon internal and external conditions of the vehicle at that time. Hence with this embodiment, the degree of acceleration restriction is determined by selecting a stepwise-varying control level whose value increases in accordance with the required degree of restriction, with the control level being selected based on the deviation extent and upon a current operating “scene” of the vehicle, i.e., a condition of normal running speed, or a very low speed (or halted) condition, as shown by FIG. 4. The vehicle control section 4 then implements control contents in accordance with the selected control level.

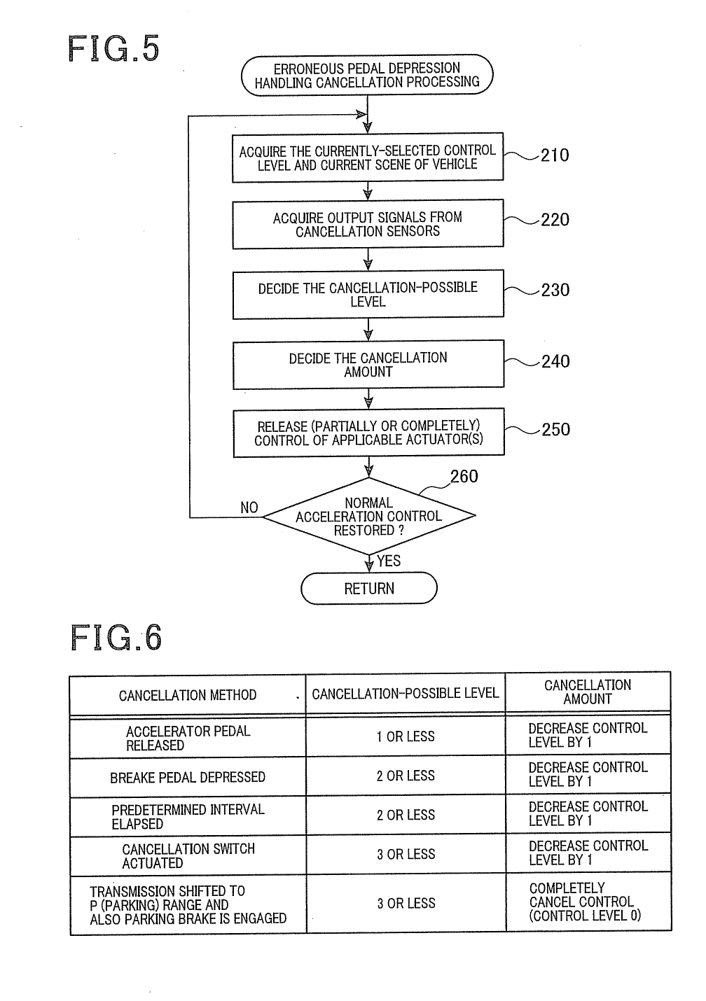

The operation of the control cancellation section 3 is described in more detail in the following. FIG. 5 is a flow diagram of a processing sequence executed by the control cancellation section 3 in parallel with the processing executed by the erroneous pedal actuation control section 2 shown in FIG. 3.

Firstly in step 210 of FIG. 5, the control cancellation section 3 acquires information expressing the currently selected control level and the scene in which the vehicle is operating, i.e., information expressing the control contents that are currently being applied by the vehicle control section 4. (Although not specifically indicated in FIG. 1, the scene information obtained by the erroneous pedal actuation control section 2 is supplied to the control cancellation section 3).

Next in step 220, if a detection signal is being outputted from one of the cancellation sensors 17 and 21 to 25, this is acquired, as a cancellation event, and a corresponding “cancellation-possible” level and cancellation amount are then determined in steps 230 and 240.

FIG. 6 is a table showing the relationship between five possible cancellation methods (i.e., cancellation events, which are opportunities for reducing control of the engine actuators 31, brake actuators 32 and warning apparatuses 33 by the vehicle control section 4), respectively corresponding “cancellation-possible” levels, and respectively corresponding cancellation amounts. The relationships are as follows. When a cancellation event occurs, if the currently selected control level is equal to or less than the “cancellation-possible” level corresponding to that cancellation event, the control level is lowered by the cancellation amount corresponding to that cancellation event.

Thus for example if the vehicle driver releases the accelerator pedal soon after erroneous depression of the accelerator pedal has been detected and the control level 3 has been selected, it will be found (in the next execution of step 240 of FIG. 5) that the currently selected control level is higher than the “cancellation-possible” level corresponding to that cancellation event (release of the accelerator pedal). Hence the control level will be left unchanged.

However if the control level is as low as 1 and the driver releases the accelerator pedal for example, the driver is presumably in a calm condition. Hence this constitutes an opportunity for acceleration restriction to be cancelled completely (by lowering the control level to zero).

Each time a predetermined time interval (with this embodiment, 3 seconds) elapses, with timing commencing from the start of applying restriction control (i.e., commencing when the erroneous pedal actuation control section 2 selects a non-zero control level), the control level is lowered by one step. In that way it is ensured that, even if no actions are taken by the driver, acceleration restriction control becomes entirely cancelled through successive lowering of the control level after some time has elapsed, enabling the driver to recover a calm condition. This feature ensures that restriction cancellation does not excessively depend upon actions by the driver.

If the detection signal from the cancellation switch 23 indicates that the switch has been actuated, the control level is lowered by one step, irrespective of the control level that is currently selected. As opposed to operation of the accelerator pedal or the brake pedal by the driver, activation of the cancellation switch 23 indicates that the driver has become calm, to at least some degree.

Hence this constitutes an opportunity to lower the control level, even if the currently selected control level is high.

Furthermore of it is detected (based on the detection signals from the shift position sensor 17 and the parking brake sensor 25) that the vehicle transmission has been set to the P (parking) range and also that the parking brake has been engaged, then irrespective of the control level which is currently set at that time, the control level is lowered to zero, so that no control is applied to the engine actuators 31, brake actuators 32 and warning apparatuses 33 by the vehicle control section 4. Such actions by the driver tend to indicate a calm state of mind, so that control for restricting acceleration of the vehicle can be safely eliminated entirely.

Thus in step 250 following step 240, the currently set control level may be lowered by one or more steps, i.e., by the cancellation amount determined in step 240. Second control contents corresponding to the resultant control level and the current scene (as shown in FIG. 4) are then outputted from the control cancellation section 3 to the vehicle control section 4, which thereby partially or completely releases control of the engine actuators 31, brake actuators 32 and warning apparatuses 33.

Next in step 260, a decision is made as to whether the normal condition has been returned to (i.e., the selected control level has become 0). If so, the processing of FIG. 5 is ended while otherwise, step 210 is returned to and the processing sequence repeated.

The control level is thereby lowered to zero, by successive executions of the processing sequence of FIG. 5.

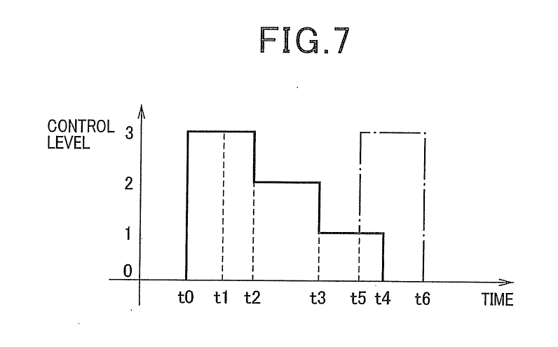

A specific example of the operation will be described referring to FIG. 7. In FIG. 7 it is assumed that at time point t0, the vehicle is running normally (i.e., at over 10 km/h) on a downhill slope (gradient more than 10%), and that the driver accidentally depresses the accelerator pedal strongly at that time. As a result, the rate of accelerator opening will greatly exceed the judgement threshold value (i.e., by more than 25%). In that case, in step 140 of FIG. 2, the erroneous pedal actuation control section 2 judges that the deviation extent is “large” and so sets a first control level of 3. Since the vehicle is judged to be operating in the “normal running” scene, control contents corresponding to control level 3 for the case of the “normal running” scene are determined (as shown in FIG. 4) in step 170.

When step 180 is then executed, it is judged that the newly determined control level (3) is higher than the currently set control level (0), i.e., the required degree of acceleration restriction is greater than is currently being applied. Thus step 190 is then executed, to supply the control contents determined in step 170 to the vehicle control section 4.

The vehicle control section 4 thereby controls the warning apparatuses 33 to generate the maximum strength of warning indication, controls the engine actuators 31 to apply the maximum degree of acceleration restriction (i.e., acceleration is completely prevented) and controls the brake actuators 32 to apply intervention braking. The vehicle thereby becomes halted.

Thereafter at time point t1, the driver releases the accelerator pedal. The “cancellation-possible” level corresponding to this cancellation event is 1 or less. Since this is lower than the currently set control level (3), that control level is left unchanged (i.e., a cancellation amount of zero is determined in step 240). Hence in the succeeding execution of step 250, control of the engine actuators 31, brake actuators 32 and warning apparatuses 33 by the vehicle control section 4 remains unchanged.

Subsequently at time point t2, the vehicle driver actuates the cancellation switch 23. The “cancellation-possible” level corresponding to this cancellation event is 3 or less, and the currently set control level is 3. Hence in response to the detection signal from the cancellation switch 23, the control cancellation section 3 (at step 240 of FIG. 5) sets the cancellation amount as 1 step, lowers the control level from 3 to 2, and outputs second control contents corresponding to control level 2 and the normal running scene. As shown in FIG. 4, these cause the warning apparatuses 33 to generate a medium strength of warning indication, and the engine actuators 31 to completely prevent acceleration, while no braking intervention is be applied by the brake actuators 32. In that condition, if the driver does not depress the brake pedal, the vehicle may move slowly due to “creeping” caused by the automatic transmission. However the vehicle will not accelerate if the accelerator pedal is depressed.

Thereafter, at time point t3 a signal is received from the timer 24 indicating that the predetermined time interval has elapsed, so that (in the next execution of step 240) the control cancellation section 3 lowers the control level is by one step, from 2 to 1. and supplies corresponding control contents to the vehicle control section 4. The warning apparatuses 33 thereby are controlled to generate a medium strength of warning indication, the engine actuators 31 applies a medium degree of acceleration restriction, and no braking intervention is applied.

With this embodiment, a medium degree of acceleration restriction consists of restricting the degree of acceleration (at any specific rate of accelerator opening) to 0.5 times the degree during normal operation.

In this condition, if the driver does not depress the brake pedal or the accelerator pedal, the vehicle may move by “creeping”, while if the driver depresses the accelerator pedal the vehicle will accelerate, but only at half of the normal acceleration rate.

Thereafter, at time point t4, if the driver depresses the brake pedal or again releases the accelerator pedal, the control cancellation section 3 (in the next execution of step 240) lowers the control level from 1 to 0, and commands the vehicle control section 4 to completely release control of the engine actuators 31 and the warning apparatuses 33, i.e., supplies control contents corresponding to control level 0. Generation of warning indications is thereby ended and normal acceleration control is restored.

Thus with the above example, after erroneous depression of the accelerator pedal has been detected during operation of the vehicle in the “normal running” scene, the control level is lowered by 1 level each time an event occurs which is an opportunity for canceling all or part of the control applied to the engine actuators 31, brake actuators 32 and warning apparatuses 33 by the vehicle control section 4. The control level is thereby successively lowered from 3 to 0, and normal operation of the vehicle restored.

As a further example referring again to FIG. 7, it is assumed that, with the vehicle in the “starting/low-speed running” scene, the driver depresses the accelerator pedal strongly at time point t5. The erroneous pedal actuation control section 2 thereby judges (in the next execution of step 140 of FIG. 5) that is the deviation extent is “large”, and so selects control level 3 in step 170 of FIG. 2.

Next it is judged in step 180 that this control level is higher than the currently selected control level (zero). Thus step 190 is then executed, to transmit control contents corresponding to control level 3 to the vehicle control section 4. The vehicle control section 4 thereby applies maximum acceleration restriction, halting the vehicle.

The control level may thereafter be reduced to zero by one step at a time in response to successive cancellation events, as described for the preceding example. However in this second example it is assumed that at time point t6, the driver sets the vehicle transmission to the P range and engages the parking brake. In that case, the control cancellation section 3 will find in the next execution of step 240 (based on the detection signals from the shift position sensor 17 and parking brake sensor 25) that the cancellation amount (3) corresponding to this cancellation event is identical to the currently selected control level. Thus the control cancellation section 3 will immediately reduce the control level from 3 to zero, as illustrated in FIG. 7. Control of the engine actuators 31, brake actuators 32 and warning apparatuses 33 by the vehicle control section 4 is thereby immediately terminated, so that normal behavior of the vehicle is restored.

Thus as can be understood from the above, when specific detection signals are received by the control cancellation section 3 from the brake pedal sensor 22, the cancellation switch 23, or the timer 24 (i.e., respective examples of a No. 1 category of cancellation sensor), the control level is lowered by 1 step. However when specific detection signals are received from both the shift position sensor 17 and the parking brake sensor 25 (constituting in combination an example of a No. 2 category of cancellation sensor), the control level is immediately set to zero, and corresponding control contents supplied to the vehicle control section 4. Thus the shift position sensor 17 and parking brake sensor 25 serve in combination as means for enabling the user to immediately cancel all control applied by the vehicle control section 4, and so immediately restore the vehicle to normal behavior.

As can be understood from FIG. 4, the type of control applied by the vehicle control section 4 in the “starting/low-speed running” scene differs from that during operation in the “normal running” scene only when control level 1 or 2 is selected.

As described above, when it is detected that the driver has erroneously depressed the accelerator pedal, control contents corresponding to one of a plurality of stepwise-varying control levels are implemented by the engine actuators 31, brake actuators 32 and warning apparatuses 33. When a cancellation event is detected (based on a detection signal from one or more of the cancellation sensors 17, 21-25), a stepwise-varying cancellation amount is determined based on that detection signal. The currently selected control level is then lowered by a number of steps equal to the cancellation amount.

Thus, each time a cancellation event is detected, the control cancellation section 3 causes the vehicle control section 4 to release all or part of the control applied to the engine actuators 31, brake actuators 32 and warning apparatuses 33.

This provides safer operation, for the following reasons. If acceleration has become completely prevented, then unless the driver can immediately set the transmission to the P range and also engage the parking brake, a plurality of cancellation events must occur before the restriction is completely released. That is, stepwise-varying release of control of acceleration restriction by the vehicle control section 4 is performed (if the driver does not set the transmission to the P range and engage the parking brake) in a sequence: [completely inhibit acceleration→partially enable acceleration→completely enable acceleration].

It is thus probable that when acceleration restriction control becomes completely released, the vehicle driver will have reached a calm state of mind.

Such a form of operation also has the following advantage. Each time a cancellation event occurs, the acceleration restriction control contents are lowered in a stepwise manner. Thus the driver can be aware of the progress of reduction of acceleration restriction control. This reduces the possibility that the driver will feel uneasy while acceleration restriction control is being applied by the vehicle control section 4.

With this embodiment, the sequence by which acceleration restriction becomes completely cancelled depends upon the scene in which the vehicle is operating when erroneous depression of the accelerator pedal is detected. For example if the erroneous pedal actuation control section 2 selects control level 3, in the “starting/low-speed running” scene, acceleration restriction control is thereafter released in the sequence: [control level 3 control level 2 control level 1]. As shown in FIG. 4, the control contents corresponding to control level 1 in the “starting/low-speed running” scene cause only a warning indication to be generated, with no restriction of acceleration. On the other hand, if the erroneous pedal actuation control section 2 selects control level 2 in the “normal running” scene, acceleration restriction control is thereafter released in the sequence: [control level 2 control level 1-4 control level 0]. In that case, acceleration restriction is completely released only when control level 0 is reached.

### Alternative Embodiments

The invention is not limited to the above embodiment, and various modifications or alternative embodiments may be envisaged. Examples of these are as follows.

With the above embodiment as shown in FIG. 4, for the same control level, the corresponding control contents differ in accordance with the “scene”, i.e., speed range, in which the vehicle is currently operating. However it would be equally possible to apply the same control contents irrespective of the scene.

With the above embodiment, the erroneous pedal actuation control section 2 supplies first control contents to the vehicle control section 4 which correspond to a selected one of a plurality of control levels. However it would be equally possible for the erroneous pedal actuation control section 2 to transmit only control contents corresponding to a single control level (e.g., corresponding to control level 3 of the above embodiment), with the operation of the control cancellation section 3 remaining as for the above embodiment.

With the above embodiment the judgement threshold value is adjusted in accordance with conditions of the vehicle and of the environment of the vehicle, but is not adjusted in accordance with the depression extent, i.e., the degree of accelerator opening. This can be detected based on the detection signal from the accelerator pedal sensor, as the extent to which the accelerator pedal has become depressed from the fully-retracted position. It would be equally possible to increase the judgement threshold value in accordance with that accelerator pedal depression extent. In that case, the judgement threshold value could also be adjusted in accordance with detected statuses of the vehicle as described above referring to FIG. 3. That is to say, when determining a judgement threshold value by executing step 130 of FIG. 2, the normal judgement threshold value (as defined above) would be increased in accordance with the accelerator pedal depression extent.

Alternatively, instead of employing only a single set of adjusted judgement threshold values respectively corresponding to various conditions of the vehicle, as in FIG. 3, a plurality of such sets of adjusted judgement threshold values could be employed, with the sets corresponding to respectively different extents of accelerator pedal depression.

Furthermore the invention is not limited in application to a vehicle driven by an internal combustion engine, but would be equally applicable to a vehicle driven by an electric motor. In that case the function of the engine actuator 31 of the above embodiment would be performed by a device such as an inverter which controls the power developed by the electric motor.

Furthermore with the described embodiment, the functions described for the erroneous pedal depression handling apparatus are performed by a program which is stored in a memory of a computer and executed by the computer. However the invention is not limited to this. Basically the invention provides a system formed of three system modules, performing the respective functions described for the erroneous pedal actuation control section 2, the control cancellation section 3 and the vehicle control section 4 of the above embodiment. It would be equally possible to implement the functions of these system modules by hardware circuitry, e.g., using FPGAs (field-programmable gate arrays).

What is claimed is:

1. An erroneous pedal depression handling apparatus for installation in a motor vehicle, said vehicle equipped with one or more actuators respectively controllable for varying an acceleration of said vehicle;
wherein:
said apparatus comprises an erroneous pedal actuation control module, a control cancellation module and a vehicle control module;
said erroneous pedal actuation control module is configured to detect erroneous depression of an accelerator pedal of said vehicle, and respond to said detection by selecting one of a plurality of stepwise-varying control levels and supplying first control contents corresponding to said selected control level to said vehicle control module, said control levels successively increasing in is accordance with increasing degrees of acceleration restriction;
said vehicle control module is configured to effect said acceleration restriction by controlling said actuators in accordance with said first control contents;
said vehicle comprises one or more sensors designated as cancellation sensors, operative for detecting respectively different cancellation events, said cancellation events comprising events which have been predetermined as opportunities for lowering a currently selected control level;
said control cancellation module is responsive to a detection signal received from a cancellation sensor for selecting a lower control level than said currently selected control level, and for supplying second control contents corresponding to said lower control level to said vehicle control module; and
said vehicle control module cancels all or part of said control of said actuators, by applying said second control contents.

2. An erroneous pedal depression handling apparatus as claimed in claim 1, wherein:
said first control contents are predetermined to entirely prevent acceleration of said vehicle, when applied to control said actuators by said vehicle control module;
said second control contents are predetermined for restricting acceleration of said vehicle to a lower value than a normal acceleration value, with respect to a specific rate of depressing said accelerator pedal, when applied to control said actuators by said vehicle control module;
said vehicle control module, by applying control of said actuators in accordance with said second control contents, partially cancels control that is currently being applied to said actuators;
said control cancellation module is responsive to a detection signal received from a cancellation sensor, subsequent to supplying said second control contents to said vehicle control module, for supplying third control contents to said vehicle control module, said third control contents being predetermined for enabling normal acceleration of said vehicle in accordance with depression of said accelerator pedal; and
said vehicle control module, by applying control of said actuators in accordance with said third control contents, partially or completely cancels control that is currently being applied to said actuators.

3. An erroneous pedal depression handling apparatus as claimed in claim 1, comprising a plurality of cancellation sensors respectively corresponding to a first category or to a second category, and wherein said control cancellation module is configured
to be responsive to a detection signal received from a cancellation sensor of said first category for lowering a currently selected control level by one step, and supplying control contents in accordance with said lowered control level to said vehicle control module, and
to be responsive to a detection signal from a cancellation sensor of said second category for causing said vehicle control module to completely cancel said restriction of acceleration.

4. An erroneous pedal depression handling apparatus as claimed in claim 3, wherein said cancellation sensors of said first category comprise a timer, configured to supply a detection signal to said control cancellation module when a predetermined time interval has elapsed following commencement of said control applied in accordance with said first control contents.

5. An erroneous pedal depression handling apparatus as claimed in claim 3, wherein a cancellation sensor of said second category comprises a combination of a parking brake sensor and a transmission shift position sensor.

6. An erroneous pedal depression handling apparatus as claimed in claim 1 wherein said vehicle comprises an accelerator pedal sensor, and wherein said erroneous pedal actuation control module:
is responsive to a detection signal from said acceleration sensor for deriving a rate at which said accelerator pedal is currently being depressed;
establishes a judgement threshold value and compares said rate with said judgement threshold value, to obtain a deviation extent as an amount by which said rate exceeds said judgement threshold value; and
selects said control level, from said plurality of control levels, based on said deviation extent.

7. An erroneous pedal depression handling apparatus as claimed in claim 6 wherein said vehicle comprising a vehicle speed sensor, and wherein said erroneous pedal actuation control module is responsive to a detection signal from said vehicle speed sensor for judging whether said vehicle is currently operating in a first speed range or in a second speed range which is higher than said first speed range, and for selecting said control level based on said deviation extent in conjunction with a result of said judgement of speed range.

8. An erroneous pedal depression handling apparatus as claimed in claim 7, wherein said first speed range extends from zero to approximately 10 kilometers per hour.

9. An erroneous pedal depression handling apparatus as claimed in claim 6 wherein said vehicle comprises at least one status estimation sensor, for detecting a status of said vehicle or of an environment of said vehicle;
wherein said erroneous pedal actuation control module is configured to determine said judgement threshold value in accordance with a detection signal received from said status estimation sensor.

10. An erroneous pedal depression handling apparatus as claimed in claim 6, wherein said vehicle comprises a plurality of status estimation sensors and wherein said status estimation sensors are predetermined as corresponding to respective judgement threshold values;
wherein said erroneous pedal actuation control module is configured to be responsive to a detection signal received from one of said status estimation sensors for selecting said judgement threshold value corresponding to said status estimation sensor.

11. An erroneous pedal depression handling apparatus as claimed in claim 9, wherein said status estimation sensor comprises a slope sensor configured for detecting an inclination direction and a gradient of a slope upon which said vehicle is located.

12. An erroneous pedal depression handling apparatus as claimed in claim 6, wherein said erroneous pedal actuation control module is responsive to said detection signal from said accelerator pedal sensor for detecting an extent to which said accelerator pedal is currently depressed, and is configured to determine said judgement threshold value based on said depression extent.

13. A program stored in a memory of a computer and executed by said computer for implementing respective functions of an erroneous pedal actuation control module, a control cancellation module and a vehicle control module,
wherein:
said erroneous pedal actuation control module is configured to detect erroneous depression of an accelerator pedal of said vehicle, and to respond to said detection by selecting one of a plurality of stepwise-varying control levels, and supplying first control contents corresponding to said selected control level to said vehicle control module, said control levels being predetermined as successively increasing in accordance with increasing degrees of restriction of is acceleration of said vehicle;
said vehicle control module is configured to apply said first control contents to control said actuators, for restricting said acceleration in accordance with said selected control level;
said vehicle comprises at least one sensor, designated as a cancellation sensor, for detecting a predetermined status of said vehicle;
said control cancellation module is configured to acquire said selected control level, to respond to a detection signal received from said cancellation sensor by determining a lowered control level which is lower than said selected control level by an integral number of steps, and to supply second control contents corresponding to said lowered control level to said vehicle control module; and
said vehicle control module is configured to respond to said second control contents by canceling all or part of said control applied to said actuators.
